(19) United States
(12) Patent Application Publication
(10) Pub. No.: US 2010/0283725 A1
(43) Pub. Date: Nov. 11, 2010

(54) MANIPULATING DEVICE AND PORTABLE ELECTRONIC APPARATUS

(75) Inventors: DANNY TANG, Taipei (TW); Chun-Ming Tai, Taipei (TW)

Correspondence Address: J C PATENTS, 4 VENTURE, SUITE 250, IRVINE, CA, 92618, US

(73) Assignee: Inventec Appliances Corp., Taipei (TW)

(21) Appl. No.: 12/699,223

(22) Filed: Feb. 3, 2010

(30) Foreign Application Priority Data
May 7, 2009 (TW) 98207852

(51) Int. Cl. G09G 5/00

(52) U.S. Cl. 345/156

(57) ABSTRACT

A manipulating device suitable for connecting to a body of a portable electronic apparatus is provided, wherein the body has a first connecting unit. The manipulating device includes a manipulating body, a pivotal shaft, a fastener and a second connecting unit. The manipulating body has a button unit including a plurality of keys. The pivotal shaft connects the manipulating body. The fastener connects the pivotal shaft and is pivoted on the manipulating body through the pivotal shaft and is connected to the body. The second connecting unit is disposed at the fastener. When the fastener is connected to the portable electronic apparatus, the second connecting unit connects the first connecting unit.

### CROSS-REFERENCE TO RELATED APPLICATION

This application claims the priority benefit of Taiwan application serial no. 98207852, filed on May 7, 2009. The entirety of the above-mentioned patent application is hereby incorporated by reference herein and made a part of specification.

### BACKGROUND OF THE UTILITY MODEL

1. Field of the Utility Model

The present invention generally relates to a manipulating device and a portable electronic apparatus, and more particularly, to a manipulating device having a pivoting structure and a portable electronic apparatus using the above-mentioned manipulating device.

2. Description of Related Art

In the contemporary information age, the people's lives rely on a portable electronic apparatus more and more. As a matter of fact, everywhere in our lives the portable electronic apparatuses are used, for example, handset, electronic dictionary, personal digital assistant (PDA) and handheld game console, etc. In terms of the handset available on the market, the functions thereof become more and more powerful. Along with the astonishing development, a processor of a handset has had great data processing capability so as to smoothly execute the enhanced functions. In this way, the modern handset can play game, none of which is even ranked behind the handheld game machines on the current market. It can be expected that the game function would be one of important additional functions with a modern handset.

In addition, many manufacturers are eager to reduce the weight and volume of mobile phone through developing, so that a user can carry a mobile phone more easily. Along with continuously improving the image quality, the screen size of a mobile phone is made bigger and bigger, where a layout conflict problem emerges since a limited size of a handset can not meet both the requirements of disposing keys within the available space and placing a large screen on the handset's body. However, it should be noted that the manipulability is an important requirement for PC-game where too small dimension or too narrow layout of the keys would downgrade a good manipulability and bring the user with quite inconvenience.

### SUMMARY OF THE UTILITY MODEL

Accordingly, the present invention is directed to a manipulating device, which enables a user to easier manipulate a portable electronic apparatus.

The present invention provides a manipulating device connected to a body of a portable electronic apparatus, wherein the body has a first connecting unit. The manipulating device includes a manipulating body, a pivotal shaft, a fastener and a second connecting unit. The manipulating body has a button unit including a plurality of keys. The pivotal shaft connects the manipulating body. The fastener connects the pivotal shaft and is pivoted on the manipulating body through the pivotal shaft and is connected to the body of the portable electronic apparatus. The second connecting unit is disposed at the fastener. When the fastener is connected to the portable electronic apparatus, the second connecting unit connects the first connecting unit.

In an embodiment of the present invention, the first connecting unit and the second connecting unit have the same interface specification of interface with another entity.

In an embodiment of the present invention, an interface of the above-mentioned second connecting unit is universal serial bus (USB) interface.

In an embodiment of the present invention, the above-mentioned manipulating device further includes an adapter connected between the first connecting unit and the second connecting unit.

In an embodiment of the present invention, the above-mentioned fastener is an elastic part providing an elastic force to hold the body of the portable electronic apparatus.

In an embodiment of the present invention, the fastener has at least a clamp for holding the portable electronic apparatus, and the fastener is an elastic part so that the clamp provides an elastic force to hold the portable electronic apparatus.

In an embodiment of the present invention, the above-mentioned fastener has an accommodating space to accommodate a part of the portable electronic apparatus.

In an embodiment of the present invention, the above-mentioned manipulating body has a containing space to contain the fastener.

The present invention also provides a portable electronic apparatus, which includes a body and a manipulating device. The body has a first connecting unit. The manipulating device is detachably disposed at the body. The manipulating device includes a manipulating body, a pivotal shaft, a fastener and a second connecting unit. The manipulating body has a button unit including a plurality of keys. The pivotal shaft connects the manipulating body. The fastener connects the pivotal shaft and is pivoted on the manipulating body through the pivotal shaft and is connected to the body of the portable electronic apparatus. The second connecting unit is disposed at the fastener. When the fastener is connected to the portable electronic apparatus, the second connecting unit connects the first connecting unit.

In an embodiment of the present invention, the body of the portable electronic apparatus further has a second button unit, and the second button unit includes a plurality of keys, wherein the portable electronic apparatus further includes a screen and a processing unit, the screen is disposed at the body of the portable electronic apparatus, the processing unit is disposed at the body of the portable electronic apparatus and electrically connected to the screen, the first connecting unit and the second button unit, wherein the processing unit is for receiving the input signals of the first button unit and the second button unit and outputting corresponding displaying signals to the screen.

In an embodiment of the present invention, the first connecting unit and the second connecting unit have the same interface specification of interface with another entity.

In an embodiment of the present invention, an interface of the above-mentioned second connecting unit is USB interface.

In an embodiment of the present invention, the above-mentioned manipulating device further includes an adapter connected between the first connecting unit and the second connecting unit.

In an embodiment of the present invention, the above-mentioned fastener is an elastic part providing an elastic force to hold the body of the portable electronic apparatus.

In an embodiment of the present invention, the fastener has at least a clamp for holding the portable electronic apparatus, and the clamp is an elastic part so that the clamp provides an elastic force to hold the portable electronic apparatus.

In an embodiment of the present invention, the above-mentioned fastener has an accommodating space to accommodate a part of the portable electronic apparatus.

In an embodiment of the present invention, the above-mentioned manipulating body has a containing space to contain the fastener.

Based on the depiction above, the manipulating device of the present invention is able to increase the manipulability of the portable electronic apparatus so that a user can easier manipulate the portable electronic apparatus and adjust the included angle between the fastener and the manipulating body by the user himself.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a portable electronic apparatus according to the first embodiment of the present invention.

FIG. 2 is a diagram of a portable electronic apparatus according to the second embodiment of the present invention.

FIG. 3 is a diagram of a portable electronic apparatus according to the third embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

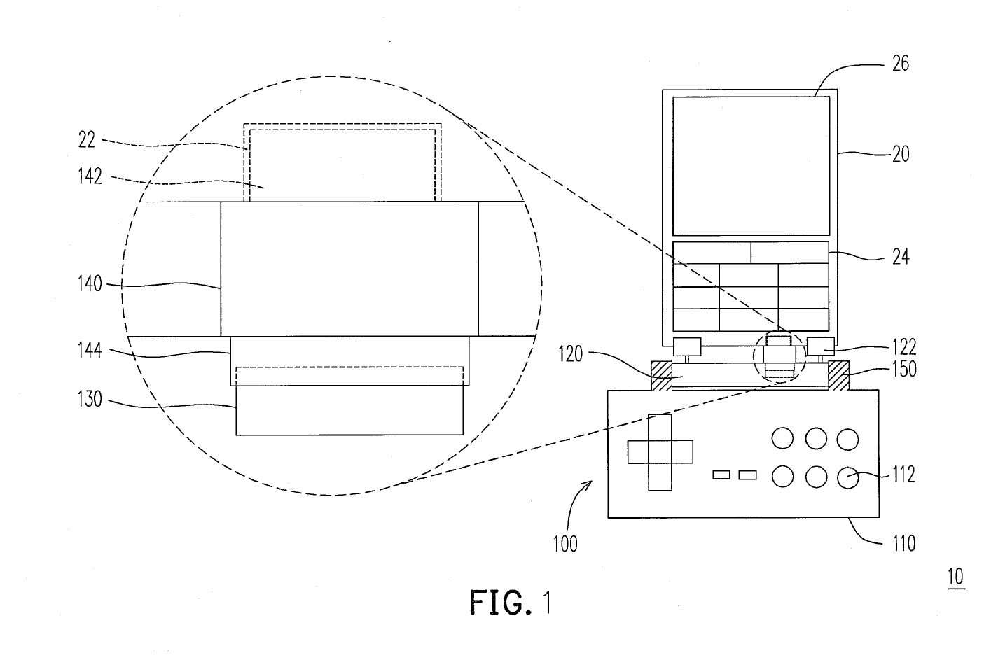

FIG. 1 is a diagram of a portable electronic apparatus according to the first embodiment of the present invention. Referring to FIG. 1, a portable electronic apparatus 10 includes a body 20 and a manipulating device 100. The portable electronic apparatus 10 in the embodiment is, for example, handset or PDA. The body 20 has a first connecting unit 22 for connecting to peripherals. The manipulating device 100 is detachably disposed at the body 20 and includes a manipulating body 110, a fastener 120 and a second connecting unit 130.

The manipulating body 110 has a first button unit 112 and the first button unit 112 includes a plurality of keys, wherein the sizes and the arrangement of the keys are designed to make the user easily manipulate. The fastener 120 is pivoted on the manipulating body 110 for connecting the body 20. When a user uses the manipulating device 100 for entering and wishes to adjust the angle of view of the body 20, the user can rotate the fastener 120 to an angle suitable to watch.

In more details, the manipulating device 100 may further includes a pivotal shaft 150 connected between the manipulating body 110 and the fastener 120 so that the fastener 120 is able to rotate in relation to the manipulating body 110 through the pivotal shaft 150. Besides, the fastener 120 may has at least a clamp 122 (two ones are shown in FIG. 1) and the body 20 is held by the clamp 122 so as to join the fastener 120 and the body 20 together. The clamp 122 may be an elastic metal strip or a clip with a spring. In this way, the clamp 122 can not only firmly hold the body 20 through the elastic force, but also be conveniently detached down from the body 20.

The second connecting unit 130 is disposed at the fastener 120 for connecting the first connecting unit 22 when the fastener 120 is connected to the body 20 already, which means when the fastener 120 is fixed at the body 20, the contacting spots in the second connecting unit 130 and the first connecting unit 22 are electrically connected to each other so that the electrical signal of the manipulating device 100 can be transmitted to the body 20. In the embodiment, the manipulating device 100 further includes an flexible circuit board (FCB, not shown) disposed in the pivotal shaft 150 and the FCB is electrically connected to the second connecting unit 130 and the first button unit 112. When the fastener 120 rotates in relation to the manipulating body 110, the flexible and bendable FCB would twist along with the pivotal shaft 150.

In the embodiment, the second connecting unit 130 may be a USB interface, while the first connecting unit 22 on the body 20 may be an interface with another interface specification. In order to make different interfaces connected to each other for transmitting signals, the manipulating device 100 of the embodiment may further includes an adapter 140 connected to the second connecting unit 130, and the second connecting unit 130 is connected to the first connecting unit 22 via the adapter 140. The adapter 140 may include a third connecting unit 142 and a fourth connecting unit 144, wherein the interface specifications of the third connecting unit 142 and the fourth connecting unit 144 are respectively corresponding to the first connecting unit 22 and the second connecting unit 130.

When the adapter 140 is connected between the body 20 and the manipulating body 110, the input signal of the first button unit 112 can be transmitted to the second connecting unit 130 via the above-mentioned FCB; and, the second connecting unit 130 is connected to the first connecting unit 22 via the above-mentioned adapter 140. At the time, the signal entered by the user through the first button unit 112 can be sequentially transmitted to the second connecting unit 130 the fourth connecting unit 144, the third connecting unit 142 and the first connecting unit 22 and finally arrive at the body 20.

In the embodiment, the adapter 140 is for inter-converting between the first connecting unit 22 and the second connecting unit 130 wherein the first connecting unit 22 and the second connecting unit 130 have different interface specifications. Therefore, the adapter 140 should be optionally employed according to the application situation. For example, if the first connecting unit 22 and the second connecting unit 130 have the same interface specifications, the adapter 140 is not needed. The clamp 122 can be designed as a telescopic part so as to be extended or shrunk to meet the practical need. When there is no adapter 140 employed between the first connecting unit 22 and the second connecting unit 130, the clamp 122 can be shrunk so that the first connecting unit 22 and the second connecting unit 130 can be joined against each other. After that, if the adapter 140 is still employed, the user is required to extend the length of the clamp 122 only so that the clamp 122 can hold the body 20. In another embodiment, the clamp 122 has a fixed length, but the second connecting unit 130 is designed to be telescopic one. After removing the adapter 140, the user can extend the length of the second connecting unit 130 so as to make the first connecting unit 22 and the second connecting unit 130 joined against each other.

The body 20 may further have a second button unit 24, which includes a plurality of keys, and the portable electronic apparatus 10 further includes a screen 26 and a processing unit (not shown). The screen 26 is disposed on the body 20, and the processing unit is disposed inside the body 20 and connects the screen 26, the first connecting unit 22 and the second button unit 24. When the first connecting unit 22 and the second connecting unit 130 are connected to each other, the processing unit is for receiving the input signal of the first button unit 112, and after the input signal is operated and processed, the corresponding displaying signal is output to the screen 26. Similarly, the processing unit can receive the input signal of the second button unit 24 and is correspondingly converted into the displaying signal output to the screen 26.

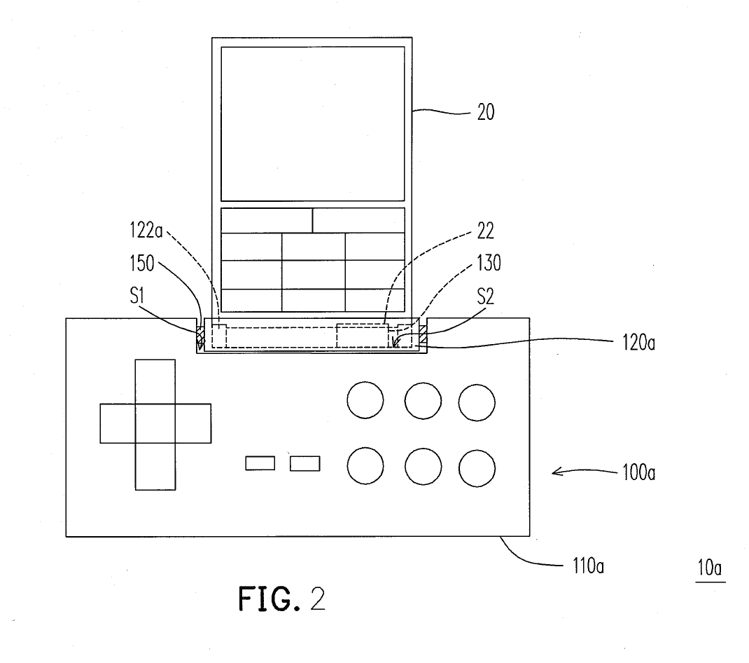

FIG. 2 is a diagram of a portable electronic apparatus according to the second embodiment of the present invention. Referring to FIG. 2, a portable electronic apparatus 10a includes a manipulating device 100a and a body 20. The manipulating device 100a includes a manipulating body 110a, a pivotal shaft 150, a fastener 120a and a second connecting unit 130. The body 20 is the same as the one in FIG. 1, and the manipulating device 100a is roughly same as the manipulating device 100 in FIG. 1, wherein all the same or similar components are notated by the same or similar marks, which is omitted to describe.

In the embodiment, the manipulating body 110a may have a containing space S1 and the fastener 120a can be disposed in the containing space S1. The fastener 120a can rotate in relation to the manipulating body 110a through the pivotal shaft 150, while the fastener 120a may also have an accommodating space S2 for placing the body 20 therein. In fact, a part of the body 20 is accommodated in the accommodating space S2.

The shape of the accommodating space S2 should match the shape of the body 20. In addition, a plurality of clamps 122a are disposed in the accommodating space S2. When the body 20 is placed in the accommodating space S2, the clamps 122a are able to hold the body 20 and the body 20 herein is firmly connected to the fastener 120a. The second connecting unit 130 can also be disposed in the accommodating space S2. When the user places the portable electronic apparatus 10a in the accommodating space S2, the second connecting unit 130 would be connected to the first connecting unit 22.

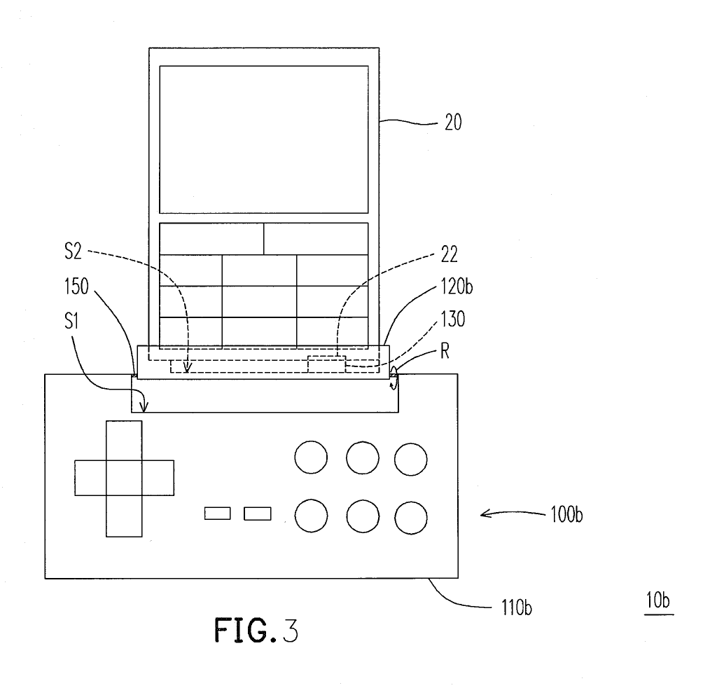

FIG. 3 is a diagram of a portable electronic apparatus according to the third embodiment of the present invention. Referring to FIG. 3, a portable electronic apparatus 10b includes a manipulating device 100b and a body 20. The manipulating device 100b includes a manipulating body 110b, a pivotal shaft 150, a fastener 120b and a second connecting unit 130. The body 20 is the same as the one in FIG. 1, and the manipulating device 100b is roughly same as the manipulating device 100 in FIG. 1, wherein all the same or similar components are notated by the same or similar marks, which is omitted to describe.

In the embodiment, the fastener 120b is a dock station having an accommodating space S2. The shape of the accommodating space S2 should match the shape of the body 20 so that when the body 20 is placed in the accommodating space S2, the body 20 would be knocked by the fastener 120b. In addition, the fastener 120b may be elastic one for holding the body 20. For example, the fastener 120b may be made of elastic material, for example, metal or rubber. In this way, the body 20 is firmly located in the accommodating space S2 through the holding action created by the elastic force.

In the embodiment, the second connecting unit 130 is disposed in the accommodating space S2. After the body 20 is placed in the accommodating space S2, the first connecting unit 22 and the second connecting unit 130 are connected to each other. Besides, the manipulating body 110 has also a containing space S1. The fastener 120b can rotate in relation to the manipulating body 110b through the pivotal shaft 150. In this way, the fastener 120b is swung into or out from the containing space S1. When the fastener 120b is swung out from the containing space S1, as shown by FIG. 3, the body 20 is located in the containing space S1, and at the time, the fastener 120b can be adjusted by rotating to have an orientation angle for watching or manipulating. When the body 20 is detached down, the fastener 120b can be swung into the containing space S1 along a direction so that the opening of the accommodating space S2 is not exposed, which is advantageous in reducing the oxidation of the second connecting unit 130.

In summary, the manipulating device of the present invention allows the user to adjust the included angle between the fastener and the manipulating body by the user himself, so that when the manipulating device is installed at the body of the portable electronic apparatus, the user can not only locate the most appropriate watching position, but also take an orientation angle for conveniently manipulating. Besides in the manipulating device of the present invention, the dimension and the layout of the first button unit of the manipulating body facilitate the manipulation of the user. It should be noted that the manipulating device of the invention is used not only in gaming, but also in normally entering data and playing multimedia. In addition, the body of the portable electronic apparatus can be held by the fastener itself or the elastic force of the clamp disposed thereon, so that the body is firmly connected to the manipulating body.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A manipulating device, suitable for connecting to a body of a portable electronic apparatus, wherein the body has a first connecting unit, and the manipulating device comprises:
a manipulating body, having a button unit comprising a plurality of keys;
a pivotal shaft, connected to the manipulating body;
a fastener, connected to the pivotal shaft so as to be pivoted on the manipulating body through the pivotal shaft, and for being connected to the body of the portable electronic apparatus; and
a second connecting unit, disposed at the fastener for connecting to the first connecting unit when the fastener is connected to the body of the portable electronic apparatus.

2. The manipulating device according to claim 1, wherein the first connecting unit and the second connecting unit have the same specification of interface with another entity.

3. The manipulating device according to claim 1, wherein an interface of the second connecting unit is a universal serial bus interface.

4. The manipulating device according to claim 1, further comprising an adapter connected between the first connecting unit and the second connecting unit.

5. The manipulating device according to claim 1, wherein the fastener is an elastic part providing an elastic force to hold the body of the portable electronic apparatus.

6. The manipulating device according to claim 1, wherein the fastener has at least a clamp for holding the body of the portable electronic apparatus.

7. The manipulating device according to claim 6, wherein the clamp is an elastic part providing an elastic force to hold the body of the portable electronic apparatus.

8. The manipulating device according to claim 1, wherein the fastener has an accommodating space to accommodate a part of the body of the portable electronic apparatus.

9. The manipulating device according to claim 1, further comprising a flexible circuit board disposed in the pivotal shaft and electrically connected between the manipulating body and the second connecting unit.

10. The manipulating device according to claim 1, wherein the manipulating body has a containing space to contain the fastener.

11. A portable electronic apparatus, comprising:
a body, having a first connecting unit;
a manipulating device, detachably disposed at the body and comprising:
a manipulating body, having a button unit comprising a plurality of keys;
a pivotal shaft, connected to the manipulating body;
a fastener, connected to the pivotal shaft so as to be pivoted on the manipulating body through the pivotal shaft, and for being fastened to the body of the portable electronic apparatus; and
a second connecting unit, disposed at the fastener for connecting to the first connecting unit when the fastener is fastened to the body of the portable electronic apparatus.

12. The portable electronic apparatus according to claim 11, wherein the body further has a second button unit comprising a plurality of keys and the portable electronic apparatus further comprises:
a screen, disposed at the body; and
a processing unit, disposed at the body and electrically connected to the screen, the first connecting unit and the second connecting unit, wherein the processing unit is for receiving input signals from the first button unit and the second button unit and outputting corresponding signals for a display on the screen.

13. The portable electronic apparatus according to claim 11, wherein the first connecting unit and the second connecting unit have the same specification of interface with another entity.

14. The portable electronic apparatus according to claim 11, wherein the manipulating device further comprises an adapter connected between the first connecting unit and the second connecting unit.

15. The portable electronic apparatus according to claim 11, wherein the fastener is an elastic part providing an elastic force to hold the body of the portable electronic apparatus.

16. The portable electronic apparatus according to claim 11, wherein the fastener has at least a clamp for holding the body of the portable electronic apparatus.

17. The portable electronic apparatus according to claim 16, wherein the clamp is an elastic part providing an elastic force to hold the body of the portable electronic apparatus.

18. The portable electronic apparatus according to claim 11, wherein the fastener has an accommodating space to accommodate a part of the portable electronic apparatus.

19. The portable electronic apparatus according to claim 11, wherein the manipulating device further comprises a flexible circuit board disposed in the pivotal shaft and electrically connected between the manipulating body and the second connecting unit.

20. The portable electronic apparatus according to claim 11, wherein the manipulating body has a containing space to contain the fastener.
